(19) United States
(12) Patent Application Publication
(10) Pub. No.: US 2026/0002429 A1
(43) Pub. Date: Jan. 1, 2026

(54) METHOD FOR COPRODUCTION OF METALS AND HYDROGEN FROM GEOLOGICAL ROCK FORMATIONS BY INJECTING AQUEOUS SOLUTION

(71) Applicant: SAUDI ARABIAN OIL COMPANY, Dhahran (SA)

(72) Inventors: Weiyao Yan, Houston, TX (US); Poorna Srinivasan, Houston, TX (US); Rajesh Goteti, Katy, TX (US)

(73) Assignees: ARAMCO SERVICES COMPANY, Houston, TX (US); SAUDI ARABIAN OIL COMPANY, Dhahran (SA)

(21) Appl. No.: 18/754,564

(22) Filed: Jun. 26, 2024

(51) Int. Cl. E21B 43/241; C01B 3/06; E21B 43/24

(52) U.S. Cl. CPC E21B 43/241; C01B 3/061; E21B 43/2405

(57) ABSTRACT

Systems and methods for coproduction of hydrogen gas and a metal are provided. Systems include at least one injection well, at least one production well in fluid communication with the at least one injection well, a source of an aqueous based solution in fluid communication with the at least one injection well, an iron containing source rock formation containing an additional metal, and a collection tank, fluidly connected to the at least one production well. Methods include identifying an iron containing source rock formation including iron and an additional metal, heating an aqueous based solution to a reaction temperature, injecting the heated aqueous based solution into the iron containing source rock formation, reacting the iron containing source rock formation and the heated aqueous based solution in a water-rock reaction to produce a post-reaction fluid including hydrogen and the additional metal, and producing the post-reaction fluid with a production well.

### BACKGROUND

Net-zero transition in world energy systems aiming at a more sustainable future involves increasing adoption of sustainable, cleaner, renewable, and economic energy sources such as wind, tidal, solar, geothermal and hydrogen energy. Hydrogen (H₂) has been identified as one of the most promising energy resources and has recently attracted special attention due to its broad applications not only as a high-quality, renewable, clean fuel, but also as a stable power and raw material for many industrial products.

Current global hydrogen demand is approximately 100 million tonnes (Mt)/year, but the International Energy Agency's (IEA) Net Zero by 2050 Roadmap requires 500 Mt/year of hydrogen by 2050. Molecular hydrogen itself is a carbon-free fuel because when consumed in a fuel cell, the final product is only water. However, the hydrogen production process (i.e., from feedstock to hydrogen) is still considered to be carbon intensive. Currently, steam reforming of natural gas or light hydrocarbons, a fossil-fuel based method, is still the dominant method (about 96%) used to commercially produce hydrogen. Although it may be “greener,” electrolysis of water (about 4%) coupled with renewable energy sources and/or CO₂ sequestration processes has a relatively higher cost compared to “less green” energy sources and is energy intensive. In addition, costs related to carbon capture and storage (CCS) and transportation of risk associated with CO₂ (and methane) leakage during the CCS process obscure the overall decarbonization efforts through the entire chain of hydrogen production.

Similar to hydrogen, demand for lithium (Li) is also expected to grow substantially in the future largely due to the increasing demand of electric batteries, as well as many other products related to ceramics, glass, metallurgy, air treatment, pharmaceuticals, and polymers. Lithium is the principal component of high-energy-density (rechargeable) batteries. In the last two decades, Li demand has grown more than three-fold and is expected to continuously rise, dominantly driven by the global fast-growing electric vehicle markets. In addition, lithium-ion batteries are also good candidates for storage cells, with longer lifespan and higher power densities compared to other battery technologies, for storing and transporting “intermittent” electricity generated, for example by wind and solar, in a more cost-effective but less carbon emission way that could support a more sustainable future. Ore-grade geologic lithium deposits or reserves are highly geologically restricted to only a few locations mostly within Chile, Australia, Argentina, and China, which comprise greater than about 77% of the worldwide Li geologic reserves and about 97% of Li production. Lacking access to economic Li reserves for most countries in the world may hinder large-scale production of Li and increase the risk of supply interruptions. Therefore, many countries desire finding new Li sources and/or recovery technologies to reduce the reliance on imports.

Accordingly, there exists a need for improved production methods of sustainable energy sources such as H₂ and rare materials used in energy applications such as Li.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a system for coproduction of hydrogen gas and a metal, including at least one injection well, at least one production well in fluid communication with the at least one injection well, a source of an aqueous based solution in fluid communication with the at least one injection well, and an iron containing source rock formation including an additional metal and located in a downhole environment, and a collection tank, fluidly connected to the at least one production well.

In another aspect, embodiments disclosed herein also relate to a method for coproduction of hydrogen gas and a metal, including identifying an iron containing source rock formation including iron and an additional metal and located in a downhole environment, heating an aqueous based solution to a reaction temperature to produce a heated aqueous based solution and injecting, using at least one injection well, the heated aqueous based solution into the downhole environment including the iron containing source rock formation. The method also includes reacting the iron containing source rock formation and the heated aqueous based solution in a water-rock reaction to produce a post-reaction fluid including hydrogen and the additional metal and producing, using at least one production well in fluid communication with the at least one injection well, the post-reaction fluid.

Other aspects and advantages of the claimed subject matter will be apparent from the following description and the appended claims.

### BRIEF DESCRIPTION OF DRAWINGS

FIG. 1 depicts a system for coproduction of hydrogen and a metal according to one or more embodiments.

FIG. 2 illustrates an example injection well system according to one or more embodiments.

FIG. 3 is a flowchart of a method for coproduction of hydrogen and a metal according to one or more embodiments.

### DETAILED DESCRIPTION

Throughout the application, ordinal numbers (for example, first, second, third) may be used as an adjective for an element (that is, any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

It is to be understood that the singular forms “a,” “an,” and “the” include plural referents unless the context clearly dictates otherwise. Thus, for example, reference to “a fluid sample” includes reference to one or more of such samples.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that one or more of the steps shown in the flowcharts may be omitted, repeated, and/or performed in a different order than the order shown. Accordingly, the scope of the invention should not be considered limited to the specific arrangement of steps shown in the flowcharts.

Although multiple dependent claims are not introduced, it would be apparent to one of ordinary skill that the subject matter of the dependent claims of one or more embodiments may be combined with other dependent claims.

Embodiments disclosed herein generally relate to systems and methods for coproduction of hydrogen gas and metals from geologic rock formations. In some embodiments, the additional metal is lithium (Li). In some embodiments, systems, and methods for coproduction of hydrogen gas and Li are carried out by injecting an aqueous based solution downhole and allowing a water-rock reaction to proceed, thereby producing hydrogen gas and hydrogen- and/or Li-enriched brines.

Systems and methods disclosed herein may advantageously produce hydrogen gas and a metal-rich brine. The metal-rich brine may include a pure metal and/or metal compounds (e.g., Li₂CO₃, Li₂O, LiOH) which may require further processing to extract pure metal from the metal compound.

As described in the background section, hydrogen gas is an important carbon-free fuel source and demand for hydrogen gas is currently growing. Similarly, lithium demand is also growing due to its use in electric batteries, among other applications.

As mentioned above, although molecular hydrogen is a carbon-free energy fuel, its production by conventional means such as steam reforming of coal or natural gas (also known as black and gray hydrogen, respectively), or electrolysis of water even combined with carbon sequestration or powered by renewable energy, could lead to variable extents of greenhouse gas emissions. Geologic hydrogen extraction, on the other hand, may be produced directly from chemical reactions occurring underground, such as water-rock reactions according to embodiments disclosed herein. For example, water-rock reactions that are initiated in Fe-containing underground source rock formations (e.g., peridotite) under sufficient geothermal heat and pressure may be used to produce H₂. For this reason, olivine, especially fayalite, is considered a desirable mineral for H₂ production due to high Fe²⁺ content. Furthermore, favorable conditions for H₂ production in water-rock reactions occur from a wide temperature range of 50-400° C., with the highest production rate occurring at about 250-300° C.

Conventionally, lithium production dominantly relies on the extraction of natural geologic reserves above or near Earth's surface such as lithium-rich ores and salt-lake brines. In contrast, embodiments disclosed herein focus on advantageously extracting Li from underground geological rock by injecting aqueous based solutions into the rock to initiate a water-rock reaction. Naturally, gases and metallic element-enriched hydrothermal fluids have been observed discharging at or near mid-ocean ridges where crustal or mantle rocks readily react with infiltrated seawater under relatively high temperature. Li, as a highly fluid-mobile element, generally tends to concentrate in fluid but deplete in rock at higher temperatures of greater than or equal to 200° C. during water-rock reactions, whereas at lower temperatures (i.e., less than about 200° C.), this behavior may be reversed. However, Li gain or loss in the reacted fluids is also controlled by other factors such as the initial fluid and rock compositions and water/rock mass ratios. Notably, Li concentration in the fluid can be significantly increased by 5-50 times at a temperature range of 200-400° C. after the reaction, which is technically (and economically) suitable for Li extraction. Therefore, one way to concentrate Li in fluid is to optimize the water-rock reaction between Li-enriched rocks and Li-depleted fluid under relatively high temperature (>200° C.) but with relatively low water/rock mass ratios (<1).

The similarities of temperatures (and other conditions) for maximizing hydrogen production and concentrating lithium in fluids during water-rock reactions are thus advantageously employed in embodiments disclosed herein to simultaneously extract both hydrogen and lithium from reacted fluids. As mentioned, the efficiency of hydrogen production and lithium concentration is mainly controlled by rock and fluid composition, temperature and water/rock mass ratio during the reaction. Conversely, current methods and processes are focused on either hydrogen exploration/production or lithium extraction, and therefore, there exists a need and a possibility for simultaneous recovery of hydrogen and lithium from the same brine.

The basic chemical process accepted to account for hydrogen production during water-rock reaction is:

$$2 FeO + {H}_{2} O = {Fe}_{2} {O}_{3} + {H}_{2} \qquad ( Equation 1 )$$

During the reaction, minerals containing Fe²⁺ reduce H₂O to H₂, and Fe²⁺-containing mineral is oxidized to Fe³⁺-rich mineral(s). A typical example is hydrothermal alteration of peridotite to serpentinite (i.e., serpentinization) during which hydrogen is produced in association with serpentine, magnetite, and/or brucite. For example, an average peridotite rock source provides around 2-4 kg H₂/m³ upon complete oxidation. Crustal rocks themselves may contain up to 0.235 mL/g hydrogen (e.g., Mid-Atlantic Ridge basalts) that may be extracted together with the reaction-generated hydrogen.

During the reaction, as water is reduced to H₂, the surrounding rocks are also altered and oxidized. At the same time, due to the relatively high temperature, Li is extracted from the country rock, and gradually concentrates in the percolating fluids. The water-rock reaction is exothermic and will continuously release heat, likely proceeding spontaneously without or with minimal additional energy input. Furthermore, the released heat can accelerate the reaction in situ, and as a continuous process, might be used as long-term power to support the hydrogen and lithium extraction/refining.

One or more embodiments disclosed herein propose systems and methods for coproduction of lithium and hydrogen from geological rock formations by interacting optimal source rocks with water solutions under relatively high temperatures (≥200° C.), followed by simultaneous recovery of lithium and hydrogen from the reacted brines (and residual source rocks). As previously discussed, water-rock reactions can take place anywhere once the right conditions are met. Temperatures of less than 200° C. may also work for hydrogen production with an expected slower production rate but may not be suitable to concentrate Li in the reacted brines. Therefore, a relatively high reaction temperature is required to increase the reaction efficiency and ensure that the water-rock reaction proceeds quickly enough for the production of hydrogen while simultaneously concentrating Li in the brines.

### System for Coproduction of Metals and Hydrogen

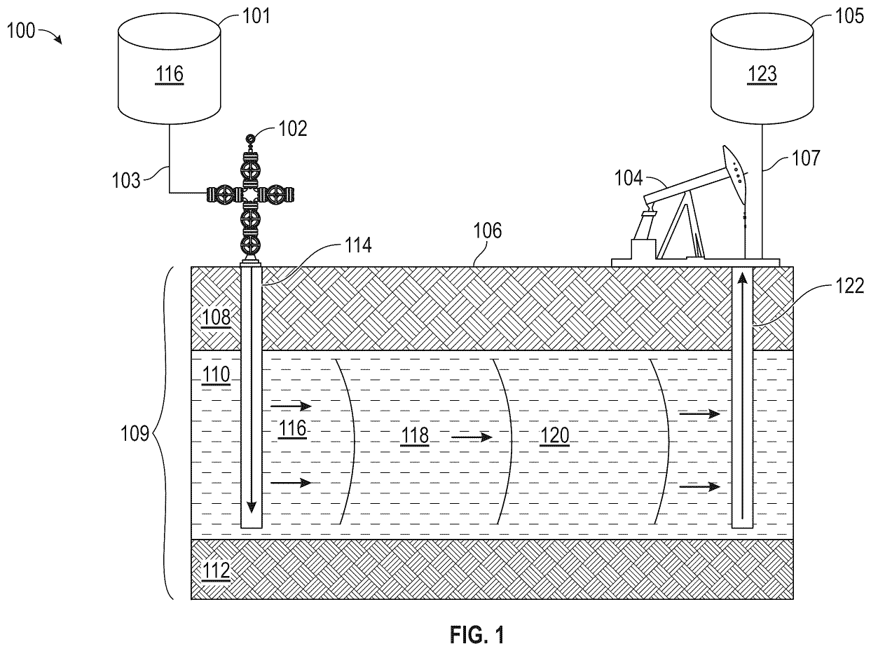

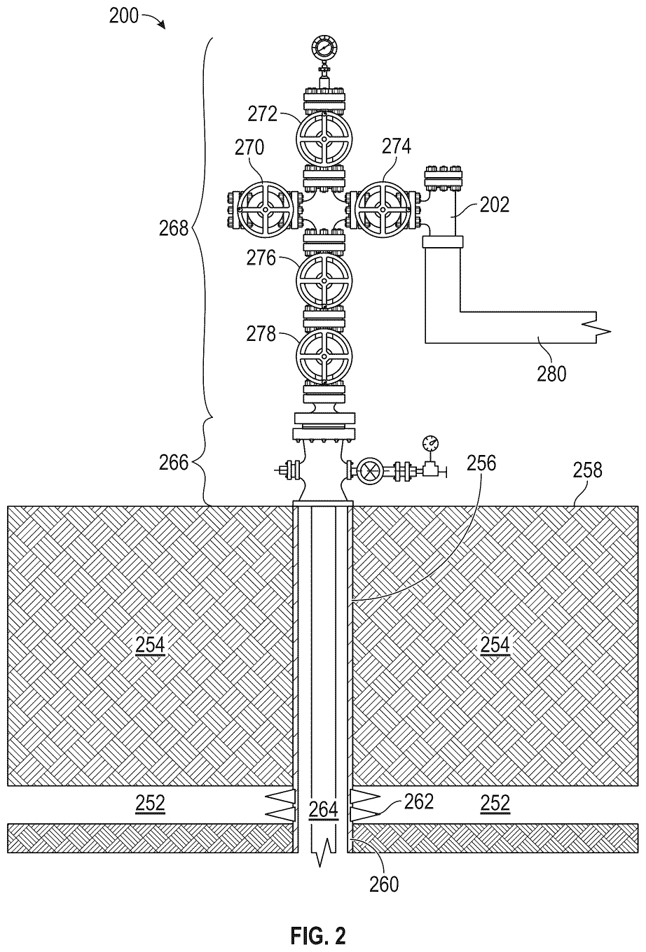

FIG. 1 illustrates an example system for coproduction of hydrogen gas and metals from subsurface geological rock formations according to one or more embodiments disclosed herein. The system 100 of FIG. 1 includes an injection well 102, a production well 104, a source of an aqueous based solution 101, an iron containing source rock formation 110 containing both iron and at least one additional metal, located in a downhole environment, and a collection tank 105. The injection well 102 may be any injection well known in the art capable of supplying a fluid to a downhole environment. An example injection well is described in more detail in FIG. 2 below. The production well 104 may be any production well known in the art capable of producing a fluid from a downhole environment.

In some embodiments, existing injection and production wells may be used for the systems and methods disclosed. In some embodiments, new injection and/or production well(s) may be drilled in order to carry out systems and methods disclosed herein. The injection and production wells of one or more embodiments may vertical and/or horizontal depending on the regional evaluation of geological, technical, and economic conditions. In some embodiments, multiple wells may be drilled surrounding the water injection well to maximize the efficiency of hydrogen and metal coproduction.

In one or more embodiments, the system 100 includes only one injection well 102 and only one production well 104, as shown. However, in some embodiments multiple injection wells and multiple production wells may be included in the system. In one or more embodiments, at least one injection well 102 is in fluid communication with at least one production well 104 such that a fluid may flow or migrate in the downhole environment 109 in a direction from one or more of the at least one injection wells 102 to one or more of the at least one production wells 104.

In some embodiments, the downhole environment may include a hydro-fracturing well (also known as a hydraulic fracturing well). Hydro-fracturing technology is commonly used to increase oil and gas production in oil and gas wells. Generally, the hydraulic fracturing process begins with the drilling of a long vertical or angled well that can extend a mile or more into the subsurface. As the well nears a rock formation of interest (i.e., formations having natural gas or oil deposits) drilling may then gradually turn horizontal and extend horizontally as far as thousands of feet. Steel pipes called casings may be inserted into the well, and the space between the rock and the casing may be fully or partially filled with cement. Small holes or perforations in the casing may be made with a perforating gun, or the well may be constructed with pre-perforated pipe. Fracking fluid is then pumped in at a pressure high enough to create new fractures or open existing ones in the surrounding rock. This allows the oil or gas to flow to the surface for gathering, processing, and transportation. Contaminated wastewater may also be stored in pits and tanks or disposed of in underground wells. As would be understood by one of ordinary skill in the art, hydraulic fracturing typically requires an extensive amount of equipment, such as high-pressure, high-volume fracking pumps, blenders for fracking fluids, and storage tanks for water, sand, chemicals, and wastewater. Hydro-fracturing technique uses direct displacement, specialized high pressure pumps to inject water and other fluids under high pressure into a bedrock formation via a well. In one or more embodiments, an aqueous based solution may be injected into an iron containing source rock formation containing at least one additional metal using a hydro-fracturing well system to perform methods disclosed herein.

As would be understood by one of ordinary skill in the art, the downhole environment may include equipment and sensors not shown in the Figures for the purpose of monitoring or facilitating methods disclosed herein. For example, a thermocouple, temperature sensor, or heater may be installed in the downhole environment. The thermocouple or temperature sensor may be used to monitor a downhole fluid temperature and the heater may be used to heat the downhole fluid to a temperature suitable for conducting a water-rock reaction, according to one or more embodiments disclosed herein.

Returning to FIG. 1, in the system 100, the injection well 102 and the production well 104 may be located on the surface of the earth 106. The injection well 102 may be in fluid communication 103 with the source of the aqueous based solution 101. The injection well 102 may be used to inject an aqueous based solution 116 from the aqueous based solution source 101 into a downhole environment 109.

The aqueous based solution of one or more embodiments may be any solution which includes water (H₂O) as a primary component. A “primary component” is defined herein as a component having a concentration of about 50 vol. % or more in a solution or mixture, based on a total volume of the solution or mixture. According to embodiments disclosed herein any aqueous based solution can be used to react with source rocks to conduct methods as disclosed, as water is the only theoretically required reactant in a water-rock reaction. The aqueous based solution of one or more embodiments may be purified water, meteoric water, underground water, seawater, produced water (e.g., from mining, oil and gas production, aquifer, seawater desalination, etc.), hydrothermal brine, ultrapure water, and synthetic fluid solution. In some cases, economic accessibility, rather than composition, of the water solution may determine what aqueous based solution is used. However, special care must be taken when using untreated produced water as it could cause severe pollution to the surrounding environment and ecosystem.

The source of the aqueous based solution according to one or more embodiments may be self-contained (such as a sea or ocean, a pond, a lake, a river, or the like) or the aqueous based solution may be acquired and/or stored in a suitable storage container in fluid communication with the injection well, including but not limited to fracking or evaporation ponds, trucks, tanks, and the like.

In one or more embodiments, the aqueous based solution may also include a catalyst. The catalyst may be used to help stimulate the water-rock reaction, thereby expediting a rate of hydrogen generation and/or metal enrichment in the aqueous based solution. In one or more embodiments, the catalyst may be any natural minerals (e.g., spinel), rocks, or fluids, as well as synthetic materials, which can expedite the hydrogen generation rate and/or lithium enrichment in the reacted brine.

As would be understood by one of ordinary skill in the art, although not explicitly shown in the Figures, other equipment may be included in the system and methods disclosed herein. For example, a pump or pumps may be used to inject solutions through the injection well, or extract the solution from the production well, heaters may be used to heat the solution prior to injecting downhole or in the downhole environment, etc.

As would be understood by one of ordinary skill in the art, the downhole environment 109 may include a variety of geological formations, including an upper formation 108 and a lower formation 112, where the upper formation 108 is located closer to the surface of the earth 106 compared to the lower formation 112. In one or more embodiments, the iron containing source rock formation 110 may be located relatively between the upper and lower formations 108, 112.

The iron containing source rock formation containing both iron and at least one additional metal may be any rock containing relatively high amounts of iron (Fe) (e.g., higher than about 1-2 wt. %), and particularly of interest is Fe²⁺, and at least one additional metal. For example, the iron containing source rock formation of one or more embodiments may contain about 1 wt % to about 70 wt % of Fe. For example, amount of iron in the iron containing source rock formation may be in a range having a lower limit of from about 1, 5, 10, and 25 wt % to about 30, 40, 50, and 70 wt %, where any lower limit may be paired with any mathematically-compatible upper limit. Some non-limiting examples of the amount of iron in an iron containing source rock formations include about 1-2 wt % Fe for granitoid rocks, about 8-12 wt % Fe for mafic and ultramafic rocks, and about 50-60 wt % Fe for banded iron formation or greater than 60 wt % for iron ore.

The iron containing source rock formation may be mafic and ultramafic igneous rocks or ores, silicic igneous rocks, sedimentary rocks, metamorphic rocks, and the like. Examples of iron containing source rocks that have relatively high iron include but are not limited to serpentinite, kimberlite, komatiite, pegmatite, peridotite, pyroxenite, basalt, diabase, gabbro, granitoid rock, banded iron formation and clay-rich sedimentary rock. Examples of minerals that make up iron containing source rock formations include but are not limited to olivine, pyroxene, amphibole, serpentine, magnetite, spinel, mica, iolite, chlorite, and smectite.

In some embodiments, iron containing source rock formations which also contain relatively high amounts of an additional metal may also be used as the iron containing source rock formation. For example, iron containing source rock formations may include fairly high Li concentrations in addition to relatively high amounts of Fe as described above. Examples of iron containing source rock formations which include relatively high amounts of iron and fairly high Li concentrations include but are not limited to basalt, diabase, pegmatite, granitoid rock and clay-rich sedimentary rock. In some embodiments, the iron containing source rock formation includes one or more of an olivine-rich rock such as peridotite, olivine basalt, olivine gabbro, and combinations thereof.

In one or more embodiments, the iron containing source rock formation contains Fe and at least one additional metal. The additional metal contained in the source rock may be Li, Al, Ti, Ni, Zn, Co, Mn, Cu, Pb, Rb, Ga, Ge, Sb, Mo, Cr, As, Sn, W, V, rare-earth elements (Sc, Y, La, Ce, Pr, Nd, Pm, Sm, Eu, Gd, Tb, Dy, Ho, Er, Tm, Tb, and Lu), any other metal of interest, and combinations thereof. In some embodiments, the additional metal contained in the iron containing source rock formation is lithium. In some embodiments, the additional metal contained in the iron containing source rock formation is lithium and the iron containing source rock formation includes one or more of peridotite, olivine basalt, and combinations thereof.

Keeping with FIG. 1, a wellbore 114 may extend from the injection well 102 to the downhole environment 109 and through the iron containing source rock formation 110. The wellbore 114 may include casing, and the casing may be perforated, as best seen in FIG. 2 (see the description of FIG. 2, below). In one or more embodiments, the aqueous based solution 116 may be injected from the aqueous based solution source 101 to the injection well 102 and subsequently into the wellbore 114. The aqueous based solution 116 may then flow through the wellbore (or perforations in the casing of the wellbore 114) in a migration direction 118, shown by vertical arcs and horizontal arrows in FIG. 1. The production wellbore 122 may include casing. The casing in the production wellbore 122 may or may not be perforated. FIG. 1 describes a wellbore 114 which is vertical, for simplicity. However, as would be understood by one of ordinary skill in the art, the wellbore 114 may include any combination of vertical and/or horizonal sections without departing from embodiments disclosed herein.

Upon injecting a sufficient amount of aqueous based solution 116 into the iron containing source rock formation 110, a migrated fluid 120 flows in the direction of the production well 104. The migrated fluid 120 flows in the migration direction 118 to the production wellbore 122 and subsequently toward the production well 104. Upon flowing from the production well 104, the migrated fluid 120 may enter a collection tank 105. The collection tank 105 may be fluidly connected 107 to the production well 104. As will be described in more detail in the following method sections, the migrated fluid 120 may include a post-reaction fluid 123 according to one or more embodiments. The migrated fluid may also include water, oil from surrounding oil deposits, dissolved gases, dissolved minerals and/or metals, and the like.

A “sufficient amount of aqueous based solution” is defined herein as a quantity of the aqueous based solution which saturates the iron containing rock source formation in the migration direction such that a portion of the migrated fluid begins to travel to the production wellbore and subsequently out of the production well. A sufficient amount of aqueous based solution may be confirmed, for example, by observing water flowing from a production well (i.e., 104 in FIG. 1), predicted by modeling of a hydro-fracturing process based on geological conditions of the downhole environment, or any other method known in the art.

The collection tank of one or more embodiments may be any suitable storage container in fluid communication with the production well, including but not limited to industrial fluid tanks, poly tanks, pressure tanks, and the like. In some embodiments, the storage container may be made of corrosion resistant materials. In one or more embodiments, the collection tank may include one or more collection tanks. In some embodiments, the one or more collection tanks may include a collection tank configured to store an aqueous based solution and a separate collection tank may be configured to store a gas, such as H₂.

As will be described in the method sections, below, the collection tank 105 may hold the post-reaction fluid 123. In some embodiments, the post-reaction fluid 123 may be analyzed for hydrogen and/or metal composition on-site. In some embodiments, hydrogen and/or metals may be extracted from the post-reaction fluid 123 located in the collection tank 105 on-site. In some embodiments, hydrogen gas extracted from the post-reaction fluid 123 in the collection tank 105 may be used as a fuel source to fuel coproduction operations at the production well 104, the injection well 102, or surrounding coproduction sites.

Similarly, as will be described further in method sections below, the migrated fluids 120, including but not limited to the post-reaction fluid 123, may be transported to an off-site location (not shown). In one or more embodiments, the post-reaction fluid 123 may be analyzed for physical and chemical properties, such as volume, viscosity, density, pH, metal concentration, and anion species at the off-site location. In one or more embodiments, analysis instruments may include: for gas composition analyses-Gas Chromatography (GC), Gas Chromatography-Mass Spectrometry (GCMS), Isotope Ratio Mass Spectrometer (IRMS), etc. and for fluid chemical composition analysis: Inductively Coupled Plasma Mass Spectrometry (ICP-MS), Inductively Coupled Plasma-Optical Emission Spectrometry (ICP-OES), Ion Chromatography (IC), Liquid Chromatography-Inductively Coupled Plasma Mass Spectrometry (LC-ICPMS), etc. In some embodiments, hydrogen and/or metals may be processed and purified from the post-reaction fluid 123 at the off-site location. In some embodiments, hydrogen gas extracted from the post-reaction fluid 123 at the off-site location may be used as a fuel source or sold.

In one or more embodiments, the downhole fluids may be analyzed using downhole sensors. For example, hydrogen concentration in downhole fluids may be measured using a micro gas chromatography system. Similarly, lithium concentration in downhole fluids may be measured using a lithium detection sensor, including but not limited to a lithium ion sensor or a lithium ion selective electrode (ISE).

In one or more embodiments, downhole sensors may include well logging tools. A well logging tool is often attached to wireline and run downhole to measure a variety of reservoir properties in situ in the wellbore, or to retrieve samples and bring them to the surface to be measured. The tool type may vary based on the type of property being measured. For example, the logging tool may be a bottom-hole sampler, a transducer, a mechanical caliper, an ultrasonic tool, a thermocouple, a gamma ray source, or any other well logging tool known in the industry. The logging tool is used to produce a set of data versus well depth, also called a well log. Examples of a well log may be any commonly known in the oilfield industry, for example, an acoustic log, a caliper log, a density log, a pressure-temperature log, a resistivity log, a mud log, a gamma log, among others.

In one or more embodiments, the sensor or sensors may be included in a sensor assembly. The sensor assembly may be positioned adjacent to a drill bit and coupled to the drill string. Sensors may also be coupled to a processor assembly that includes a processor, memory, and an analog-to-digital converter for processing sensor measurements. For example, the sensors may include acoustic sensors, such as accelerometers, measurement microphones, contact microphones, hydrophones, hydrogen gas detection sensors, lithium sensors, and the like. Likewise, the sensors may include other types of sensors, such as transmitters and receivers to measure resistivity, gamma ray detectors, etc. The sensors may include hardware and/or software for generating different types of well logs (such as acoustic logs or density logs) that may provide well data about a wellbore, including porosity of wellbore sections, gas saturation, bed boundaries in a geologic formation, fractures in the wellbore or completion cement, and many other pieces of information about a formation.

FIG. 2 shows an example injection well system according to one or more embodiments. The system 200 of FIG. 2 illustrates an example injection well including the injection well 102 of FIG. 1. In the oil and gas industry, as illustrated by the system 200 of FIG. 2, fluids are produced from a reservoir 252 in a formation 254 by drilling a wellbore 256 into the formation 254, establishing a flow path between the reservoir 252 and the wellbore 256, and conveying the fluids from the reservoir 252 to a surface 258 through the wellbore 256. A casing 260 may be installed in wellbore 256. In some embodiments, the casing 260 may be perforated to have perforations 262 into the reservoir 252 to allow a flow of the fluids to enter the wellbore 256. Typically, a production tubing 264 is disposed in the wellbore 256 to carry the fluids to the surface 258. The production tubing 264 hangs from a wellhead 266 at the surface 258. The production tubing 264 extends past the reservoir 252, thereby forming a flow conduit from the reservoir 252 to surface 258.

A tree (also known as a Christmas tree) 268 is disposed on top of the wellhead 266 to control the flow of fluids into or out of the wellbore 256, depending on whether it is an injection well or a production well. Christmas tree 268 includes a configuration of valves to control the fluids being injected into or pumped out of the wellbore 256. For example, the Christmas tree 268 may have an injection wing valve 270, a swab valve 272, a production wing valve 274, an upper master valve 276, and a lower master valve 278. When an operator is ready to conduct well operations the valves 270-278 are either opened or closed to control the fluids being injected into or pumped out of the wellbore 256.

During injection, the production wing valve 274 and the swab valve 272 are closed while the injection wing valve 270, the upper master valve 276, and the lower master valve 278 are open to allow for fluids to be injected through the Christmas tree 268 and into the wellbore 256. During production, the injection wing valve 270 and the swab valve 272 are closed while the production wing valve 274, the upper master valve 276, and the lower master valve 278 are open to control or isolate fluid flow through a choke valve 202. From the choke valve 202, the fluids are transported via a production flow line 280, to a production storage, transport, or facility. The choke valve 202 is a mechanical device to control flow rates and pressure drops of the produced fluids. For example, an operational function of the choke valve 202 is to produce the fluids from the wellbore 256 at the desired rates by the introduction of human intervention to manually control the drawdown pressure.

As described in FIG. 1, the system 200 of FIG. 2 may be used to inject an aqueous based solution 116 from the aqueous based solution source 101 into a downhole environment 109. The injection well system 200 represents only one example injection well (102 in FIG. 1) and shall not be taken as limiting. Any suitable injection system may be used to carry out systems and methods as described in one or more embodiments disclosed herein.

### Method for Coproduction of Hydrogen and a Metal

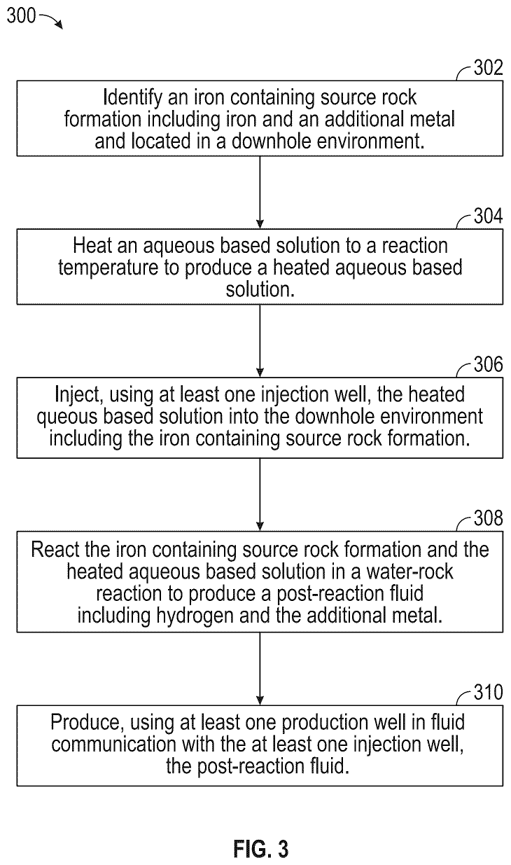

One or more embodiments disclosed herein also include a method 300 for coproduction of hydrogen and a metal, as shown in the flowchart of FIG. 3. In one or more embodiments, the method 300 includes, in step 302, identifying an iron containing source rock formation containing Fe and an additional metal. The iron containing source rock formation may be located in a downhole environment, for example, the downhole environment 109 shown in FIG. 1.

The additional metal according to one or more embodiments may be any metal as described in the sections above. The iron containing source rock formation according to one or more embodiments may be any iron containing source rock formation containing relatively high amounts as described in the sections above. In some embodiments, the additional metal is Li, and the iron containing source rock formation is one or more of peridotite, olivine basalt, olivine gabbro, and combinations thereof. The downhole environment according to one or more embodiments may be any downhole environment as described in the sections above.

Keeping with FIG. 3, in one or more embodiments, the method 300 includes, in step 304, heating an aqueous based solution to a reaction temperature. As shown in the system of FIG. 1, the aqueous based solution 116 may be contained in an aqueous based solution source 101 fluidly connected 103 to the injection well 102. Upon heating the aqueous based solution to a reaction temperature, a heated aqueous based solution is produced. The aqueous based solution according to one or more embodiments may be any aqueous based solution as described in the sections above. In some embodiments, the aqueous based solution includes a catalyst, such as any catalyst as described in the sections above. In some embodiments, the aqueous based solution includes the catalyst, and the catalyst is a natural mineral such as spinel. The reaction temperature according to one or more embodiments may be in a range of from about 200° C. to about 400° C. For example, the reaction temperature may be in a range having a lower limit of from about 200° C., 225° C., and 250° C. to an upper limit of about 300° C., 350° C., and 400° C., where any lower limit may be paired with any upper limit.

Any technique known in the art may be used to heat the aqueous based solution. For example, a thermal fluid heater located near or surrounding the source of the aqueous based solution may be used to heat the aqueous based solution to the reaction temperature. The aqueous based solution may also be heated during injection by the injection well or may be heated downhole, for example using a wellbore heater, a down-hole heater, a downhole heat exchanger, or the like. The water-rock reaction according to one or more embodiments is exothermic and may continuously release heat, such that the water-rock reaction may proceed spontaneously without or with minimal additional energy input. Furthermore, the released heat may help to accelerate the reaction in situ, and as a continuous process.

Returning to FIG. 3, in one or more embodiments, the method 300 also includes, in step 306, injecting the heated aqueous based solution into the downhole environment using at least one injection well (for example, injection well 102 in FIG. 1 and injection well system 200 in FIG. 2). As previously described, the heated aqueous solution may be injected downhole into a formation containing an iron containing source rock formation, where the iron containing source rock formation includes one or more metals.

In some embodiments, the method further includes saturating the iron containing source rock formation with the heated aqueous based solution during the injecting step. Saturating the iron containing source rock formation according to one or more embodiments refers to injecting a sufficient amount of fluid (i.e., heated aqueous based solution) using an injection well, into a formation such that the fluid flows through the formation and out of a production well which is in fluid communication with the injection well.

In some embodiments, the method further includes pressurizing the heated aqueous based solution to produce a heated, pressurized aqueous based solution. A water-rock reaction according to one or more embodiments may occur independent of pressure. However, pressurizing a fluid may advantageously assist with an ability to inject the fluid downhole. Any technique known in the art may be used to pressurize the heated aqueous solution of one or more embodiments. Non-limiting examples for pressurizing the heated aqueous solution include use of a pump or pump truck.

In some embodiments, the heated aqueous based solution is pressurized to a pressure of greater than a fracture gradient of the iron containing source rock formation. A “fracture gradient” is defined as the pressure gradient required to induce fractures in a specific rock at a specific depth. Accordingly, in one or more embodiments, the exact value of the fracture gradient may vary depending on the exact type of iron containing source rock formation and the depth of the source rock in the downhole environment. By way of example only, the fracture gradient of a formation may be in a range of from about 50 psi to about 15,000 psi.

In one or more embodiments, the method 300 further includes, in step 308, reacting the iron containing source rock formation and the heated aqueous based solution in a water-rock reaction. Upon reacting the iron containing source rock formation and the heated aqueous based solution via the water-rock reaction, a post-reaction fluid containing hydrogen and the additional metal is produced. The water-rock reaction according to embodiments disclosed herein may be the water-rock reaction of Equation 1, as shown above.

The water-rock reaction may occur for any sufficient amount of time necessary for carrying out the reaction. The time period necessary for carrying out the reaction according to one or more embodiments may be between a few days to several months and up to years. The reaction time period may depend on a composition of the source rock, properties of the injected aqueous based solution (pH, salinity, composition, etc.), the amount of injected aqueous based solution (which may impact the water to rock mass ratio) as well as temperature, and pressure (related to source rock formation depth), and if a catalyst is used. In one or more embodiments, the well may be shut in during the water-rock reaction to prevent leakage of both hydrogen generated and the injected water from the well.

In one or more embodiments, the water-rock reaction (Equation 1) may be governed by a water to rock mass ratio. Control of the water to rock mass ratio is important because reactions occurring at low water to rock mass ratios (i.e., not well controlled to be less than about 1) the aqueous based solution may instead lose lithium or other metals to the formation, resulting in the lithium enrichment in the residual source rock formation, rather than concentrating lithium in the aqueous based solution for later extraction. The water to rock mass ratio according to one or more embodiments may be less than about 1 water mass/rock mass. For example, the water to rock ratio in the water-rock reaction may have a value of less than about 1, less than about 0.8, less than about 0.5, or less than about 0.25 by mass.

In some embodiments, the water-rock reaction may produce a solid product, for example serpentinite. Production of a solid product may cause an increase in volume, compared to a volume of the source rock, as large as about 40%. In addition, the source rock may thermally expand due to the thermodynamics of the water-rock reaction (i.e., spontaneous, exothermic reaction). Expansion of the source rock by the mechanisms discussed, may form new fractures in the downhole environment, where fresh source rocks may be exposed to the aqueous based solution and thus the water-rock reaction may continue in the freshly exposed source rock.

In one or more embodiments, progression of the water-rock reaction may be monitored by analyzing the composition (i.e., analyze the hydrogen and metal concentrations) and other physical properties of a fluid produced from the production well (such as the post-reaction fluid), and downhole parameters (e.g., pressure, temperature, etc.). In one or more embodiments, the post-reaction fluid may be analyzed on-site or off-site using analysis instruments and/or downhole sensors, as described in the sections above.

Once the water-rock reaction is initiated (i.e., hydrogen is detected and/or strategic metal concentrations start to increase), fluids may be continuously injected to push fluids from injection well(s) towards production well(s), as described with respect to FIG. 1, above. Continuous injection of fluids may be required to maintain and/or facilitate the water-rock reaction. During continuous fluid injection, the injected fluids may migrate along previously induced fractures in the downhole environment and react with the surrounding rocks that are in direct contact with the injected fluids.

Upon conducting the water-rock reaction, the method 300 of one or more embodiments further includes, in step 310, producing the post-reaction fluid using a production well (i.e., production well 104 in FIG. 1), which is in fluid communication with the at least one injection well.

In some embodiments, upon producing the post-reaction fluid using the production well, the method further includes collecting the post-reaction fluid in one or more collection tanks. As shown in FIG. 1, the collection tank 105 is fluidly connected 107 to the production well 104 and may be used to collect the post-reaction fluid 123. In one or more embodiments, the method further includes transporting the post-reaction fluid to an off-site location and extracting/purifying the hydrogen and the additional metal from the post-reaction fluid at the off-site location. As would be understood by one of ordinary skill in the art, hydrogen extracted from the post-reaction fluid may require purification (i.e., to remove other gases such as hydrogen sulfide, volatile organic compounds, and the like). Extracted hydrogen may be purified using any method known in the art, for example, using filters or membranes tailored for hydrogen purification. The additional metal may be extracted from the post-reaction fluid using any suitable method known in the art. Examples include but are not limited to concentrating the additional metal by allowing the fluid portion of the post-reaction fluid to evaporate from an open collection tank (for example, in a collection pond) and/or direct lithium extraction (including, for example, selective sorbents for adsorption, resins and sorbents for ion-exchange, selective transport membranes, solvent extraction, and the like).

In one or more embodiments, the method further includes extracting/purifying the hydrogen and the additional metal from the post-reaction fluid on-site. Extracting the hydrogen and the additional metal may be accomplished using any of the methods described above. In some embodiments, upon extracting/purifying the hydrogen and the additional metal from the post-reaction fluid, the remaining post-reaction fluid may be heated to a reaction temperature to produce a heated post-reaction fluid. In some embodiments, the heated remaining post-reaction fluid may be re-injecting into the wellbore environment using the injection well.

In one or more embodiments, in addition to extracting a metal from the post-reaction fluid, the metal may also be extracted from the iron containing source rock formation after conducting the water-rock reaction. For example, the iron containing source rock formation remaining in the downhole environment may be mined and the additional metal may be extracted from the rock either on-site or off-site.

In some embodiments, upon extracting hydrogen from the post-reaction fluid, at least a portion of the hydrogen extracted from the post-reaction fluid may power one or more operations on a wellsite. For example, the extracted hydrogen may be used to power operations related to the injection well (102 of FIG. 1), the production well (104 of FIG. 1), the process of extracting hydrogen and/or metals, and/or the process of heating the aqueous based solution, as described, or operations on surrounding well sites. The extracted hydrogen and metals may also be transported off-site and used or sold.

In one or more embodiments, once hydrogen and metal generation are no longer detected from the water-rock reaction, the source rock may be depleted. Upon depletion, in some embodiments, CO₂ may be injected for carbon sequestration and the well may be sealed.

What is claimed:

1. A system for coproduction of hydrogen gas and a metal, comprising:
at least one injection well;
at least one production well in fluid communication with the at least one injection well;
a source of an aqueous based solution in fluid communication with the at least one injection well;
an iron containing source rock formation comprising an additional metal and located in a downhole environment; and
a collection tank, fluidly connected to the at least one production well.

2. The system of claim 1, wherein the additional metal is one or more metal selected from the group consisting of Li, Al, Ti, Ni, Zn, Co, Mn, Cu, Pb, Rb, Ga, Ge, Sb, Mo, Cr, As, Sn, W, V, Sc, Y, La, Ce, Pr, Nd, Pm, Sm, Eu, Gd, Tb, Dy, Ho, Er, Tm, Tb, and Lu.

3. The system of claim 2, wherein the additional metal is Li.

4. The system of claim 1, wherein the downhole environment comprises a hydro-fracturing well.

5. The system of claim 1, wherein the source of the aqueous based solution is selected from the group consisting of a sea, an ocean, a pond, a lake, a river, a fracking pond, an evaporation pond, a truck, a tank, and combinations thereof.

6. The system of claim 1, wherein the aqueous based solution is selected from the group consisting of purified water, meteoric water, underground water, seawater, wastewater, hydrothermal brine, ultrapure water, produced water, and combinations thereof.

7. The system of claim 1, wherein the iron containing source rock formation is selected from the group consisting of serpentinite, kimberlite, komatiite, pegmatite, peridotite, pyroxenite, basalt, diabase, gabbro, granitoid rock, clay-rich sedimentary rock, and combinations thereof.

8. The system of claim 5, wherein the iron containing source rock formation is selected from the group consisting of peridotite, olivine basalt, olivine gabbro, and combinations thereof.

9. A method for coproduction of hydrogen gas and a metal, comprising:
identifying an iron containing source rock formation comprising iron and an additional metal and located in a downhole environment;
heating an aqueous based solution to a reaction temperature to produce a heated aqueous based solution;
injecting, using at least one injection well, the heated aqueous based solution into the downhole environment comprising the iron containing source rock formation;
reacting the iron containing source rock formation and the heated aqueous based solution in a water-rock reaction to produce a post-reaction fluid comprising hydrogen and the additional metal; and
producing, using at least one production well in fluid communication with the at least one injection well, the post-reaction fluid.

10. The method of claim 9, wherein the injecting comprises saturating the iron containing source rock formation with the heated aqueous based solution.

11. The method of claim 9, wherein the heating further comprises pressurizing the heated aqueous based solution to produce a heated, pressurized aqueous based solution.

12. The method of claim 11, wherein the heated aqueous based solution is pressurized to a pressure of greater than a fracture gradient of the iron containing source rock formation.

13. The method of claim 9, wherein the reaction temperature is in a range of from about 200° C. to about 400° C.

14. The method of claim 9, wherein the aqueous based solution comprises a catalyst.

15. The method of claim 14, wherein the catalyst comprises spinel.

16. The method of claim 9 wherein the water-rock reaction has a water to rock ratio of less than about 1 by mass.

17. The method of claim 9, further comprising:
extracting the hydrogen and the additional metal from the post-reaction fluid on-site;
heating the post-reaction fluid to the reaction temperature to produce a heated post-reaction fluid; and
re-injecting the heated post-reaction fluid into the downhole environment comprising the iron containing source rock formation using the at least one injection well.

18. The method of claim 17, further comprising:
powering one or more operations on a wellsite with at least a portion of the hydrogen extracted from the post-reaction fluid.

19. The method of claim 9, further comprising:
collecting the post-reaction fluid in a collection tank fluidly connected to the at least one production well;
transporting the post-reaction fluid to an off-site location; and
extracting the hydrogen and the additional metal from the post-reaction fluid at the off-site location.

20. The method of claim 9, wherein the additional metal is Li and the iron containing source rock formation is selected from the group consisting of peridotite, olivine basalt, olivine gabbro, and combinations thereof.
